(19) United States
(12) Patent Application Publication
(10) Pub. No.: US 2003/0110133 A1
(43) Pub. Date: Jun. 12, 2003

(54) Automated digital rights management and payment system with embedded content

(76) Inventors: L. Michael Maritzen, Fremont, CA (US); Kiyo Niwa-San, Haworth, NJ (US); Harold Aaron Ludtke, San Jose, CA (US); John Briesch, Mooristown, NJ (US)

Correspondence Address: Valley Oak Law, 5655 Silver Creek Valley Road, #106, San Jose, CA, 95138, US

(21) Appl. No.: 10/017,947

(22) Filed: Dec. 7, 2001

(51) Int. Cl. G06F 17/60

(52) U.S. Cl. 705/52

(57) ABSTRACT

A system and method to transmit embedded content for use by a transaction device are described in detail below. In addition, authorization for use of the embedded content can be confirmed locally within the transaction device. Further, registration and payment for use of the embedded content can be performed locally within the transaction device. In one embodiment, access is requested from a secure entity. The access to the secure entity is granted if authentication information identifying a user requesting the access is provided to the secure entity. In one embodiment, embedded content is received within a transaction device; the transaction device locally verifies an authorization to use the embedded content; and the transaction device utilizes the embedded content in response to the authorization.

### CROSS REFERENCE TO RELATED APPLICATIONS

The present application claims benefit of U.S. Provisional Patent Application No. 60/XXX,XXX filed on Dec. 7, 2000, entitled “Method and Apparatus for a Platform-independent Consumer-Centric Automated Context-Aware Switching Model Between Different Internet-Enabled Sites” listing the same inventors, the disclosure of which is hereby incorporated by reference.

### BACKGROUND OF THE INVENTION

Electronic commerce is achieving widespread use. Transactions are performed everyday over the Internet and through point of sale (POS) or bank systems. Such transactions are typically performed after the person requesting access to some information is authenticated and access is given to that person's private information, such as financial, medical, or other type of restricted records. Present systems are designed to maintain the integrity of the user's credit card, debit card, and account number. However, no measures are taken to ensure the secure authentication of the user in order to prevent unauthorized access by a potential thief.

Presently, applications providing access to sensitive information are based upon information that a potential thief may appropriate with relative ease. For example, some of the information presently required to grant access to sensitive material, such as a person's Social Security Number, date of birth, or mother maiden's name, is readily available. Once a potential thief collects any two pieces of this information, the thief may obtain access to the person's financial, medical, or other private information. In addition, most secure access systems are set up to divulge a person's entire file, once they receive the appropriate password and/or correct answers to the security questions. Therefore, a potential thief may steal the person's identity and ruin that person's credit.

Further, the traditional non-Internet area of digital rights management (DRM) is complex, and the Internet-enabled digital content DRM area is even more complex. Current DRM activities typically relate to post-sales and post-fulfillment DRM and associated payment settlement. By delaying DRM to post-sales and post-fulfillment, the merchant is vulnerable to fraud and lack of sufficient funds to cover purchases.

Additionally, each merchant typically has its own stand-alone DRM, causing the consumer to have to enter purchase information (i.e., credit card information, name, billing address, etc.) multiple times, even at a single merchant portal, in order to purchase multiple items.

Further, purchasing items for use is typically based on a whole-product and/or content per-subscription model such as an entire video or song. These systems are typically unable to handle micro-content and/or micro-payment events such as a video clip, or an audio clip.

### SUMMARY OF THE INVENTION

A system and method to transmit embedded content for use by a transaction device are described in detail below. In addition, authorization for use of the embedded content can be confirmed locally within the transaction device. Further, registration and payment for use of the embedded content can be performed locally within the transaction device. In one embodiment, access is requested from a secure entity. The access to the secure entity is granted if authentication information identifying a user requesting the access is provided to the secure entity. In one embodiment, embedded content is received within a transaction device; the transaction device locally verifies an authorization to use the embedded content; and the transaction device utilizes the embedded content in response to the authorization.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a simplified block diagram of one embodiment of a secure transaction system showing a point-of-sale terminal.

FIG. 5 is a simplified block diagram of one embodiment of a transaction privacy clearing house.

FIG. 6 is a simplified representation of one embodiment of embedded content.

FIG. 7 is a simplified representation of one embodiment of a header within embedded content.

FIG. 8A illustrates one embodiment of a process for performing a transaction with embedded content.

FIG. 8B illustrates one embodiment of a process for performing a transaction with embedded content.

FIG. 8C illustrates one embodiment of a process for performing a transaction with embedded content.

FIG. 9A illustrates one embodiment of a process for performing a viral distribution transaction with embedded content.

FIG. 9B illustrates one embodiment of a process for performing a viral distribution transaction with embedded content.

FIG. 10 illustrates one embodiment of a process for performing a transaction between multiple vendors with embedded content.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method to transmit embedded content for use by a transaction device are described in detail below. In addition, authorization for use of the embedded content can be confirmed locally within the transaction device. Further, registration and payment for use of the embedded content can be performed locally within the transaction device. In one embodiment, access is requested from a secure entity. The access to the secure entity is granted if authentication information identifying a user requesting the access is provided to the secure entity.

Security of the user's identity may be achieved in a variety of ways. In one embodiment, a single trusted location. For example, a transaction privacy clearing house (TPCH) contains user data. The user interfaces with the TPCH using the user's transaction device. The user therefore does not fill out online the electronic purchase forms at every product vendor's website. The TPCH acts as a financial transaction middleman, stripping off user identity information from transactions. As a result, the user's private information is not stored in several databases across the Internet and in private business networks. The secure locations where the financial data is stored minimizes the possibilities that hackers can access the data or accidental releases of the data can occur.

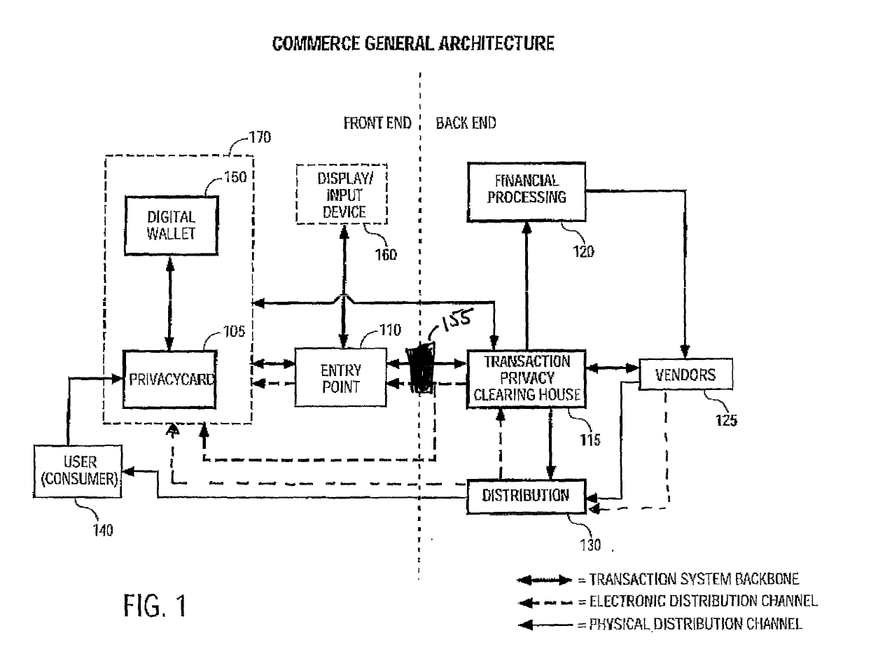

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125.

In this particular embodiment, a personal transaction device (PTD) 170, e.g., a privacy card 105, or a privacy card 105 coupled to a digital wallet 150, is used to maintain the privacy of the user while enabling the user to perform transactions. The personal transaction device 170 may include a privacy card, a digital wallet, a point of sale terminal, a laptop, a PDA, or any other device under the control of the user 140.

The personal transaction device 170 provides an interface for the user to exchange information. This exchange of information may include but is not limited to the user 140 receiving audio and/or visual content, instructions, requests, and the like from the personal transaction device 170. Further, this exchange of information may also include but is not limited to the personal transaction device 170 receiving instructions, payment authorization, authentication, and the like from the authorized user 140. In one embodiment, the personal transaction device 170 may be configured to closely resemble a standard credit card. More particularly the card may have a magnetic stripe that functions similarly to standard credit cards. In addition, the personal transaction device 170 may also contain wireless data communication, data storage and communication protocols for selectively communicating with outside devices such as a digital wallet described herein, point-of-sale terminal, or personal computer, and digital televisions.

In one embodiment, the personal transaction device 170 is configured to receive embedded content. Embedded content includes data information and header information containing various parameters relating to the data information.

In an alternate embodiment, the PTD 170 may be any suitable device that allows unrestricted access to TPCH 115. In one embodiment, the personal transaction device 170 may include a full screen that covers one side of the card. Alternately, in one embodiment in which the personal transaction device 170 is one embodiment of a privacy card, the privacy card may be coupled to device such as a digital wallet described herein, that provides a display. In one embodiment, the screen may be touch sensitive and be used for data input as well as output. In one embodiment, a user authentication mechanisms such as a fingerprint recognition for other mechanism may be built directly into the card. Furthermore, the privacy card may have a wireless communication mechanism for input and output.

A variety of user interfaces may be used. In one embodiment, and input device may be incorporated on the transaction device. Alternately or supplemental and input device may be coupled to the transaction device. In one embodiment, and input device may be provided on a digital wallet coupled to a privacy card. User inputs may be provided on the point-of-sale terminals including a personal point-of-sale terminal.

The personal transaction device information is provided to the TPCH 115 that then indicates to the vendor 125 and the user 140 approval of the transaction to be performed. The transaction device utilizes an identification to maintain confidentiality of the user's identity by applying the transaction device identification and the identity of the entity performing the transaction. Thus, all transactions, from the vendor's perspective, are performed with the transaction device.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic credit approval of a particular account. Thus, the FP 120 receives a minimal amount of information. In one embodiment, the transaction information, including the identification of goods being purchased with the credit need not be passed to the FP 120. In addition to conventional charge accounts, credit may include debit type, prepaid type, and the like. The TPCH 115 can request the credit using a dummy account ID that can be listed in the monthly credit statement sent to the user, so that the user can reconcile his credit statement. Further, the personal transaction device 105 can include functionality to cause the credit statement to convert the dummy account ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

In another embodiment, the PTD 170 interfaces through a variety of interfaces including wireless interfaces such as BlueTooth and infrared transmission; contactless transmission such as FeliCa and AmexBlue; and plug-in port transmission such as USB and RS-232C. A stand-in processor 155 (STIP) can interface with the PTD 170 in the event that the connection between the front end and the back end is disrupted for any reason. This way, the PTD 170 can gain authorization for a specified floor limit without necessarily receiving authorization from the back end. Further, this limits the amount of authorization thus minimizing fraud and insufficient funds.

In another embodiment, streaming real-time payment may occur through a variety of broadband implementations. This streaming real-time payment occurs when the user account is transacted in real-time based on the consumption rate of content, the volume of content, and the type of content. Further, in addition to traditional discrete payments, payments can also be made based on smaller segments such as the second verse of a song or the trailer for a movie.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

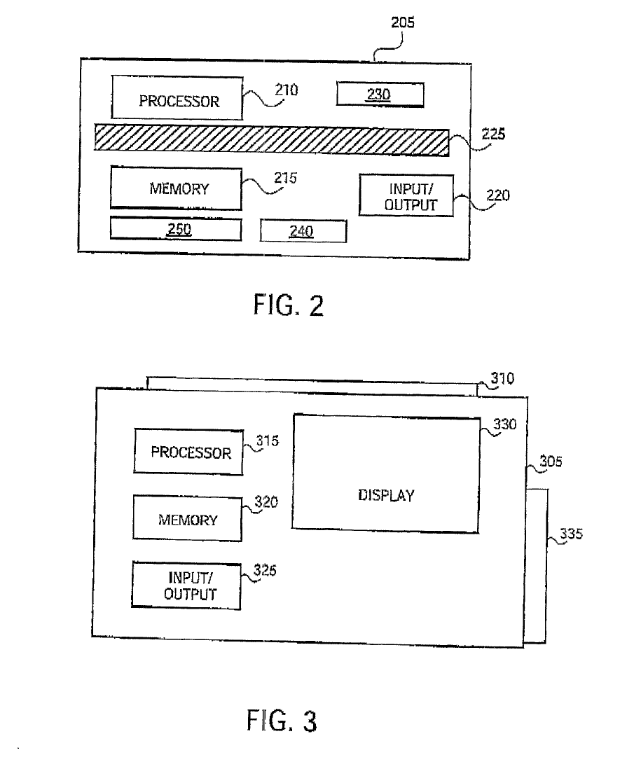

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

In another embodiment, the memory 215 also stores the embedded content received by the privacy card.

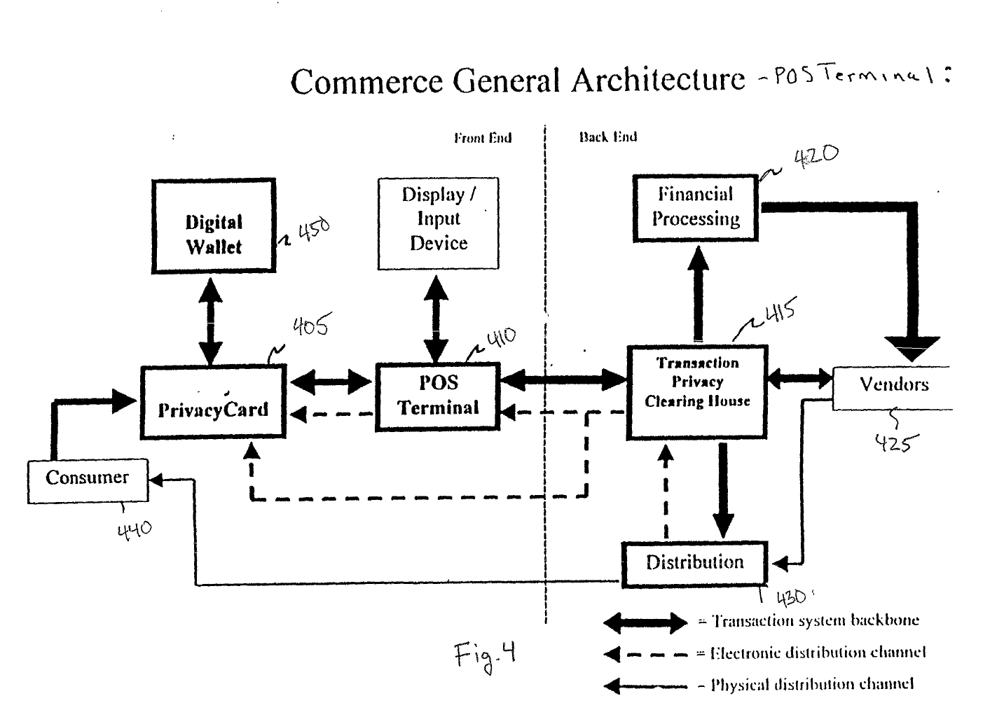

FIG. 3 is a simplified block diagram of one embodiment of a digital wallet 305 for a personal transaction device. As illustrated in FIG. 3, the digital wallet 305 includes a coupling input 310 for the privacy card 205, processor 315, memory 320, input/output logic 225, display 330 and peripheral port 335. The processor 315 is configured to execute instructions, such as those stored in memory 320, to perform the functionality described herein. Memory 320 may also store data including financial information, eCoupons, shopping lists, embedded content, and the like. The digital wallet may be configured to have additional storage. In one embodiment, the additional storage is in a form of a card that couples to the device through peripheral port 310.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

The transaction device enhances security by authenticating the user of the card prior to usage such that if a card is lost or stolen, it is useless in hands and in an unauthorized person. One means of authentication is some type of PIN code entry. Alternatively, authentication may be achieved by using more sophisticated technologies such as a biometric solution. This biometric solution can include fingerprint recognition, voice recognition, iris recognition, and the like. In addition, in one embodiment in which multiple transaction devices are used, it may be desirable to configure the first device to enable and program the second device in a secure manner. Thus, the means of communication between the first device in the second device may include mutual device verification said that can unauthorized first device may not be used to enable a particular second device that does not belong to the same or authorized user.

In one embodiment, the transaction device, point of sale terminals and/or TPCH may function to verify the authenticity of each other. For example the transaction device may be configured to verify the legitimacy of the point-of-sale terminal and/or TPCH. A variety of verification techniques may be used. For example, listen device with account and/or access issues may be maintained. For example, in one embodiment, the public key infrastructure may be used to verify the legitimacy of the user.

Communication protocols include those that allow the digital wallet to specify which of several possible data structures to use for a transaction and communication protocols that allow the digital wallet and other devices to securely share data with the transaction device. The transaction device may represent a single account such as a particular credit card, or it may represent multiple accounts such as a credit card, telephone card, and debit card.

In one embodiment, the transaction device is intended to be the means by which the user interfaces with the invention. In one embodiment, the transaction device stores e-commerce related data on behalf of the user including transaction histories, meta account information needed to carry out a transaction using the transaction privacy clearinghouse function of the system, and various content. In one embodiment, the meta account information may be an extraction of the user's real identity as opposed to the actual user's name, address, etc. For example, the TPCH keeps records of the user's real bank account numbers, but assigned a different number for use by retailers and point-of-sale terminals. For example, and actual Bank Account No. may be 1234 0000 9876 1423 could be represented as 9999 9999 9999 9999. This number, in association with the transaction card's identification, could enable the TPCH to know that the bank account No. 1234 0000 9876 1423 was actually the account being used.

The purpose of this data is to abstract the user's identity while at the same time providing the necessary information for the transaction to be completed.

In one embodiment, the personalization process of the transaction device may be as described below. In this example, the transaction device is a digital wallet. The user turns on the transaction device. This can be accomplished by touching the finger print recognition pad or simply turning a switch. The transaction device performs at start a procedure, and attacks that it has not yet been personalized. Thus, it first prompt the user to enter the secret pin code. If the pin code entry fails, the user is prompted again. Ideally the user is given a finite number of chances to enter the data. After the last failure, the device may permanently disabled itself and thus becomes useless. It may also display in message requesting that the transaction device be returned to an authorized facility.

Assuming a successful pin code entry, the user may then be prompted to enter several of the security questions ever entered into the transaction device at processing center. Some of these questions might require data entry, and others might be constructed as simple multiple-choice, with both the correct as well as incorrect answers supplied. Assuming successful response to these questions, the user may then be prompted to enter secure personal identification information such as fingerprint data. In one embodiment, in which the fingerprint data is used, the user is prompted to enter fingerprint data by successively pressing one or more fingers against the recognition pad. The device prompt the user for each fingerprint that must be entered, for example, using a graphical image of a hand with the indicated finger.

The fingerprint data entry process may be performed at least twice to confirm that the user has entered the correct data. If confirmation succeeds, the device writes the fingerprint image data into their right once memory, or other memory that is protected from accidental modification. If confirmation fails, the user is prompted to start over with entry. Failure to reliably enter the fingerprint data after a finite number of tries will result in the device permanently disabled itself, and optional he providing an on-screen message to the user to go to secure processing facility such as a bank to complete the process. After successful personalization, the device is then ready to be used for the initial set of services that the user requested during the registration process. Once the device has been initialized for secure transactions, additional services could be downloaded to the device.

One embodiment of the system that utilizes a point-of-sale terminal is shown in FIG. 4. In this embodiment, the privacy card 405 interfaces with the point-of-sale terminal 410 and that point of sale terminal 410 communicates with that TPCH 415. That TPCH 415 interfaces with the financial processing system 420, the vendor 425 and the distribution system 430. The point-of-sale terminal may be an existing or newly configured point-of-sale terminal located in a retail environment. The user 440 uses the privacy card 405 to interface to the point-of-sale terminal a manner similar to how credit cards and debit cards interface with point-of-sale terminals. Alternately, a digital wallet 450 may be used by itself or with the privacy card 405 to interface to the point-of-sale terminal 410. Alternately, a memory device may be utilized solely as the interface with that point-of-sale terminal 410.

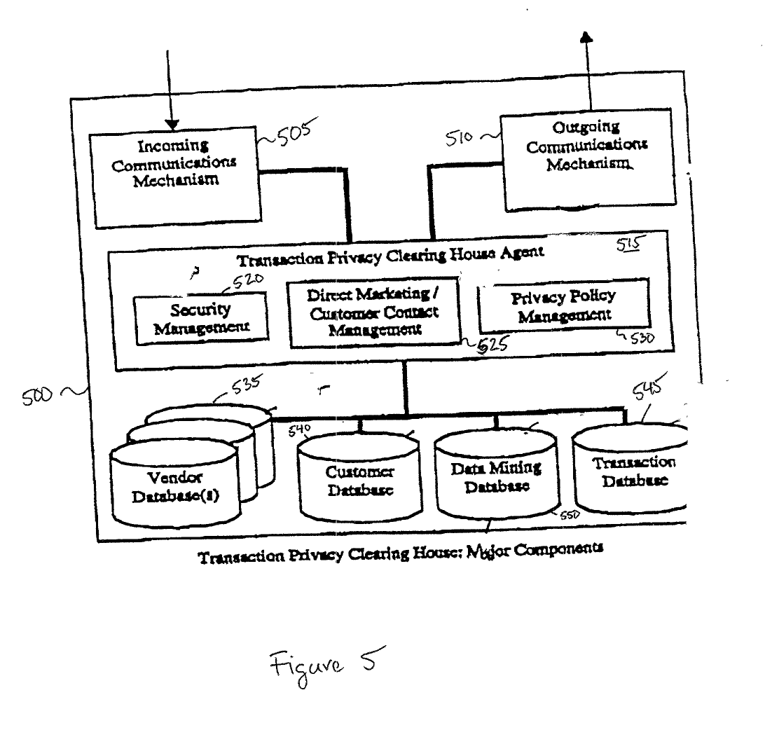

One embodiment of the TPCH is illustrated in FIG. 5. In one embodiment, the TPCH 500 is located at a secure location and is accessible to the transaction device. The TPCH 500 functions to provide the user with authorization to perform transactions; without compromising the user's identity. The TPCH 500 may be embodied as; a secure server connected to the transaction device in some form of direct connection or alternately a format in direct connection over the Internet or point-of-sale network.

Incoming communications mechanism 505 and outgoing communications mechanism 510 are the means of communicating with external retailers and vendors, as well as the transaction device such as the digital wallet. A variety of communication devices may be used, such as the Internet, direct dial-up modem connections, wireless, cellular signals, etc.

The TPCH agent 515 handles system management and policy control, informs their core functionality of the TPCH 500. In one embodiment, within the entire system, there is one clearinghouse agent, which resides permanently at the clearinghouse. Among the responsibilities handled by the agent include internal system management functions such as data mining, financial settlement and allocation of payments to internal and external accounts, embedded content management, and registration of new users joining the system.

The security management functions 520 ensure secure communications among the component internal to the TPCH 500 and the entities external to the TPCH 500. This function includes participating in secure communications protocols to open and maintain secure connections. This ensures that only authorized entities are allowed to access to data and that only authorized transaction devices can execute transactions against a user's account.

The TPCH agent 515 also provides a direct marketing and customer contact service 525, which in one embodiment is a data access control mechanism and maintain separate, secure access between various client and their databases. The data access control mechanism ensures that vendors have access only to the appropriate data in order to carry out the tasks of the system. One of the key features at the TPCH 500, the ability to carry out focused direct marketing while maintaining the privacy and identity protection of consumer, is handled by this mechanism.

The TPCH agent 515 can be configured to actively looking for content on behalf of the user as well as filter out unwanted incoming information. In one embodiment, the data may be described by XML and the agent may operate via Java applets.

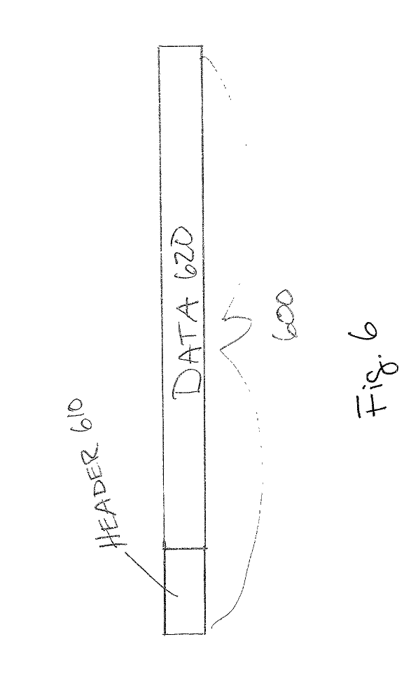

One embodiment of content which can be distributed within the secure transaction system is shown in FIG. 6. Embedded content 600 includes header information 610 and data information 620. In one embodiment, the embedded content 600 is distributed from the vendor 125 (FIG. 1) to the user 140 (FIG. 1). In another embodiment, the content 600 is propagated directly from end user to end user. In another embodiment, the embedded content 600 is compiled from more than one vendor 125.

In each of these embodiments, the embedded content 600 can be traced back to the originating vendor. The header 610 is attached to the data 620 and cannot be removed. The header 610 describes the various attributes of the associated data 620. The data 620 may include audio representations, visual representations, audio/visual representations, software applications, textual data, graphical data, or the like. For example, the content 600 may represent an album, song, song segment, movie, or movie segment.

FIG. 7 illustrates a partial list of attributes stored within the header 610 and associated with the data 620. In one embodiment, the partial list of attributes includes source(s)/author(s), location history, current location, payment amount/split, and encryption. The source(s)/author(s) represents the originating creator of the associated data. There may be multiple sources/authors for each attached associated data.

The location history describes the physical locations the embedded content has been stored on. For example, each time the embedded content is transferred to a different media, the location history saves the location information of the new location and archives the past locations. The current location of the embedded content is stored in another location for easy access.

The payment amount/split represents the amount of money that is transferred to the source(s)/author(s) each time the embedded content is utilized on a new media device. If there are more than one source/author, the amount of money collected can be split amongst the sources/authors. The encryption portion of the header 610 represents the type of encryption selected to either render the data within the embedded content useful or meaningless. The encryption portion also includes rules that describe when the data is encrypted or decrypted.

The following embodiments illustrate a variety of transactions utilizing embedded content. These transactions employ the use of steps to more clearly describe the invention and are presented as illustrative purposes and are not meant to limit the scope of the invention. Further, steps can be added, combined, or removed. Steps can also be performed in a different order.

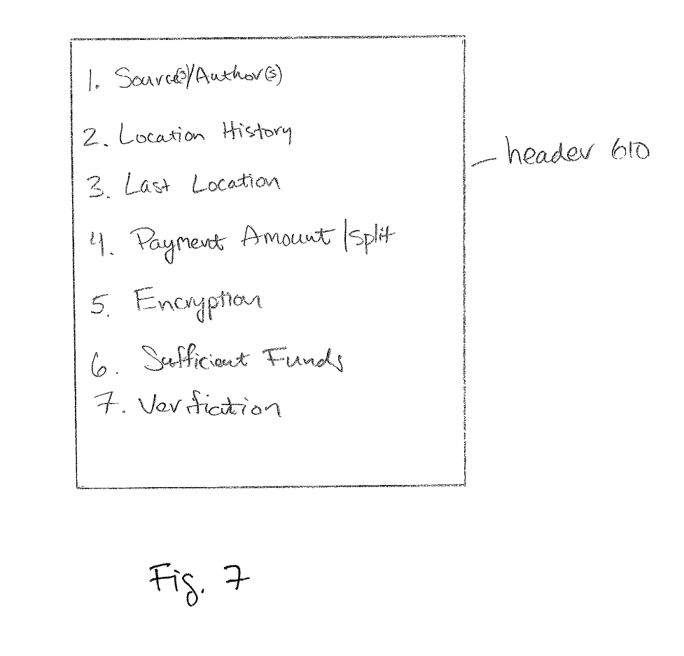

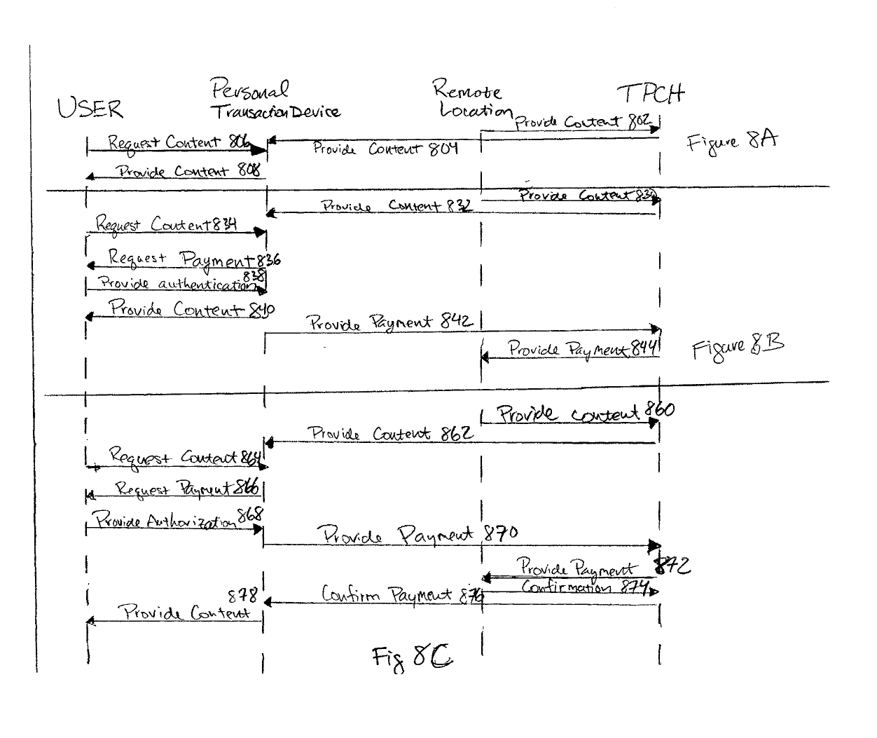

One embodiment of a transaction performed with exchanging embedded content is described with respect to FIG. 8A. At step 802, the remote location (vendor) sends embedded content to the TPCH. Next at step 804, the TPCH sends the embedded content to the personal transaction device. In another embodiment, the user requests the embedded content through the personal transaction device which in turn requests the embedded content from the remote location through the TPCH. However, in this embodiment, the embedded content resides in the personal transaction device prior to the user request. In step 806, the user requests the embedded content. A check occurs locally on the embedded content stored within the personal transaction device. Once it is determined that the use of the embedded content is authorized to be utilized, the data within the embedded content is provided to the user in a usable form from the personal transaction device in step 808.

Another embodiment of a transaction performed with exchanging embedded content is described with respect to FIG. 8B. At step 830 the remote location (vendor) sends embedded content to the TPCH. Next, at step 832 the TPCH sends the embedded content to the personal transaction device. In another embodiment, the user requests the embedded content through the personal transaction device which in turn requests the embedded content from the remote location through the TPCH. However, in this embodiment, the embedded content resides in the personal transaction device prior to the user request.

In step 834, the user requests the embedded content. A check occurs locally on the embedded content stored within the personal transaction device. The check reveals that the embedded content within this personal transaction device is not authorized. In step 836, the personal transaction device requests payment from the user based on the header within the embedded content. The header can provide the amount of payment requested. In step 838, the user provides the personal transaction device with authorization to provide payment for the embedded content. This authorization may need authentication by the personal transaction device as described above. The embedded content is provided to the user in a useful format in step 840. In some embodiments, the personal transaction device checks internally to ensure sufficient funds exist to provide payment to the TPCH prior to releasing the embedded content to the user. In some embodiments, the data must be decrypted in order to be useful to the user. In step 842, payment authorization is provided from the personal transaction device to the TPCH. In step 844, final settlement is provided to the remote location from the TPCH in response to the payment of the embedded content.

The embodiment illustrated in FIG. 8B allows the user to utilize and pay for the data locally within the transaction device without an active connection to the TPCH. For example, the embedded content provided to the personal transaction device in step 832 could have occurred in a prior session. Also, the content can be provided to the user from the personal transaction device in step 840 without an immediate connection to transmit payment authorization in step 842 as long as sufficient funds are confirmed locally in the personal transaction device.

In yet another embodiment, a transaction performed with exchanging embedded content is described with respect to FIG. 8B. At step 860, the remote location (vendor) sends embedded content to the TPCH. Next, at step 862, the TPCH sends the embedded content to the personal transaction device. In another embodiment, the user requests the embedded content through the personal transaction device which in turn requests the embedded content from the remote location through the TPCH. However, in this embodiment, the embedded content resides in the personal transaction device prior to the user request.

In step 864, the user requests the embedded content. A check occurs locally on the embedded content stored within the personal transaction device. In this embodiment, the check reveals use of the embedded content within this personal transaction device is not authorized. In step 866, the personal transaction device requests payment from the user based on the header within the embedded content. In step 868, the user provides the personal transaction device with authorization to provide payment for the embedded content. This authorization may need authentication by the personal transaction device as described above. In step 870, payment authorization is provided from the personal transaction device to the TPCH. In step 872 final settlement is provided to the remote location from the TPCH in response to the payment of the embedded content. In step 872, confirmation of final settlement is transmitted from the remote location to the TPCH. In step 876, this confirmation is sent to the personal transaction device. After receipt of the confirmation, the embedded content is provided from the personal transaction device to the user in a useful format in step 840. In some embodiments, the data must be decrypted in order to be useful to the user.

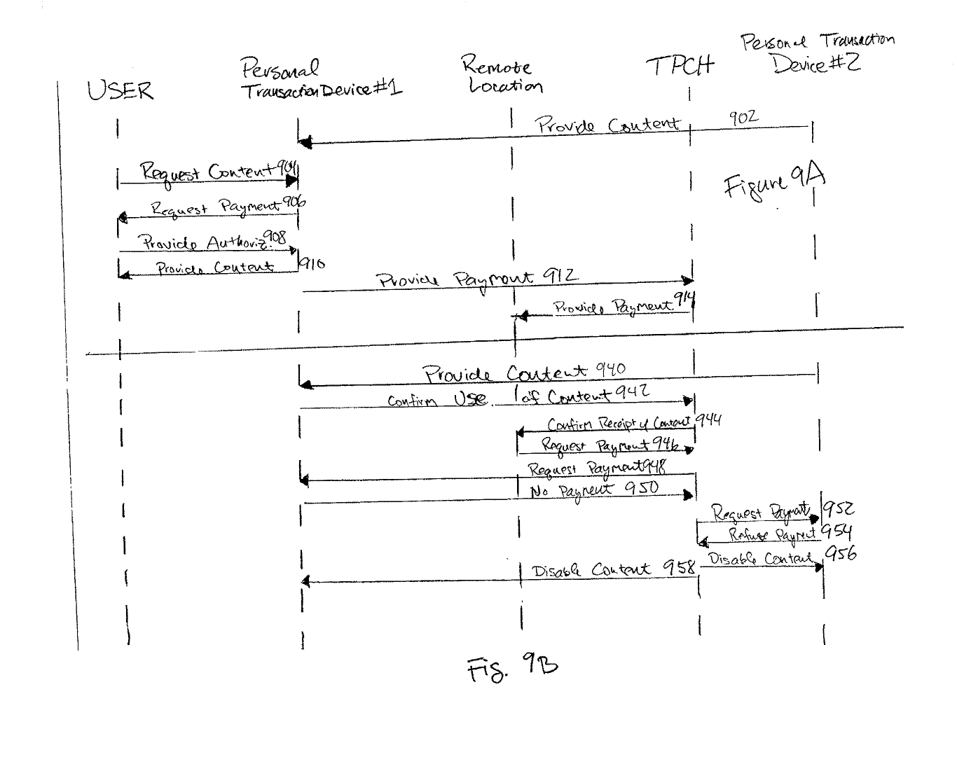

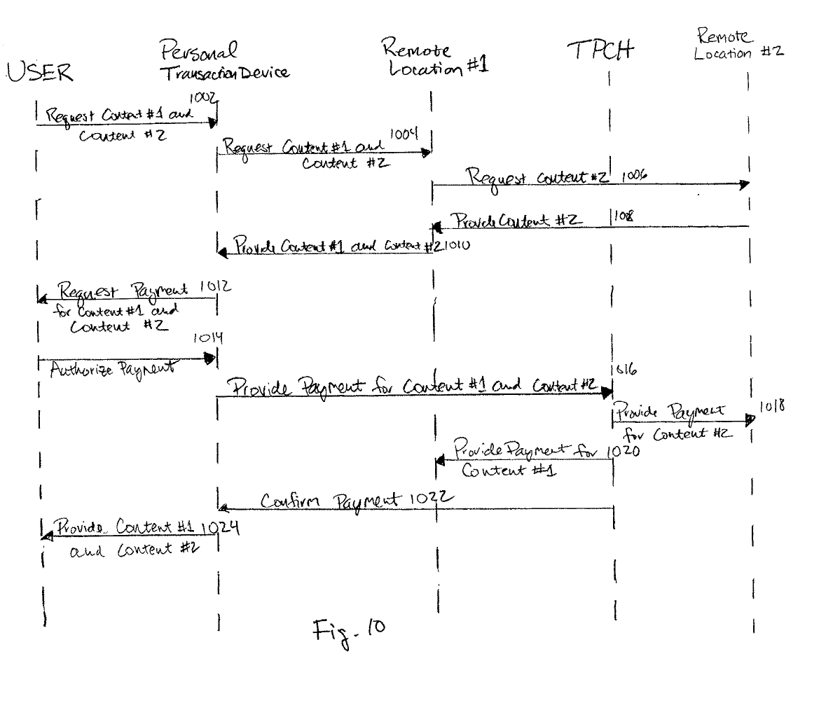

One embodiment of a viral distribution transaction performed with exchanging embedded content is described with respect to FIG. 9A. In step 902 personal transaction device #2 transmits embedded content to personal transaction device #1. Personal transaction devices #1 and #2 are remote devices respective to each other. In step 904, user (associated with the personal transaction device #1) requests the embedded content from the personal transaction device #1. The personal transaction device #1 determines that payment is needed to access the embedded content and requests payment from the user in step 906. The user provides payment authorization to the personal transaction device #1 in step 908. In step 910, the embedded content is provided to the user by the personal transaction device #1.

Payment authorization is forwarded to the TPCH from the personal transaction device #1 in step 912. Final settlement is provided to the remote location which is the author of the embedded content in step 914. In another embodiment, a referral payment is also made to the personal transaction device #2 for providing the embedded content to the personal transaction device #1.

One embodiment of a viral distribution transaction performed with exchanging embedded content is described with respect to FIG. 9B. In step 940, the personal transaction device #2 transmits embedded content to personal transaction device #1. Personal transaction devices #1 and #2 are remote devices respective to each other.

In step 942 the personal transaction device #1 confirms unauthorized use of the embedded content and transmits this confirmation to the TPCH. The unauthorized use can be triggered by the embedded content. In step 944 the TPCH notifies the remote location (source) of the unauthorized use. In step 946 the remote location transmits a demand for payment to the TPCH. In turn, the TPCH forwards the demand for payment to the personal transaction device #1 in step 948. In step 950, a “no payment” response is transmitted from the personal transaction device #1 to the TPCH. A demand for payment is transmitted to the personal transaction device #2 through the TPCH in step 952. The personal transaction device #2 transmits a “no payment” response to the TPCH in step 954.

In response, the TPCH transmits a disable command to the embedded content within the personal transaction device #2 in step 856. In response, the TPCH transmits a disable command to the embedded content within the personal transaction device #1 in step 858.

In another embodiment, the embedded content in the personal transaction device #1 remains encrypted until payment is received by the vendor.

One embodiment of a multi-vendor transaction performed with exchanging embedded content is described with respect to FIG. 10. In step 1002, the user requests video content from the personal transaction device. This requested video content is a combination of content #1 from remote location #1 and of content #2 from remote location #2.

The personal transaction device transmits the video content request to the remote location #1 in step 1004. In step 1006, the remote location #1 transmits a request for content #2 from the remote location #2. The remote location #2 transmits the content #2 in an embedded content form to the remote location #1 in step 1008. In step 1010, the remote location #1 transmits the content #1 and the content #2 (received from remote location #2) with their embedded headers intact to the personal transaction device.

In step 1012, a request for payment of the video content is transmitted to the user from the personal transaction device. In this embodiment, the payment amount is the sum of the payment for content #1 and content #2. In step 1014, the user authorizes the personal transaction device to make a payment. The personal transaction device transmits payment authorization to the TPCH in step 1016.

Based on the embedded payment information within the content #2, the TPCH provides a final settlement to the remote location #2 in step 1018. Based on the embedded payment information within the content #1, the TPCH provides a final settlement to the remote location #1 in step 1020. A payment confirmation is provided to the personal transaction device from the TPCH in step 1022. The video content is provided to the user from the personal transaction device in step 1024.

From the user's perspective, the request and payment authorization for the video content came from the remote location #1 even though additional necessary content was provided from a different source. By utilizing the embedded content format, purchasing a product from multiple vendors and finalizing the settlement for multiple vendors are seamlessly handled. Since each vendor utilizes embedded content, the amount for final settlement stays attached to the corresponding data content and does not require separate additional record keeping.

The foregoing descriptions of specific embodiments of the invention have been presented for purposes of illustration and description.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A transaction system comprising:
a. a transaction device having a storage device wherein the transaction device is configured for interfacing with a user;
b. embedded content residing within the storage device of the transaction device,
wherein the embedded content is available to the user in response to a verification within the transaction device.

2. The system according to claim 1 further comprising a backend module configured for tracking a location of the embedded content.

3. The system according to claim 1 wherein the embedded content contains audio data

4. The system according to claim 1 wherein the embedded content contains visual data.

5. The system according to claim 1 wherein the embedded content contains a financial balance of the user.

6. The system according to claim 1 wherein embedded content contains the amount charged for use of the embedded content.

7. The system according to claim 1 wherein the embedded content contains credit data of the user.

8. The system according to claim 1 wherein the embedded content contains a location history of the embedded content.

9. The system according to claim 1 wherein the embedded content contains a current location of the embedded content.

10. The system according to claim 1 wherein the embedded content contains encryption information.

11. The system according to claim 1 wherein the embedded content contains ownership information related to the embedded content.

12. The system according to claim 1 wherein the embedded content contains textual data.

13. The system according to claim 1 wherein the embedded content contains graphical data.

14. A method comprising:
a. receiving embedded content within a transaction device;
b. locally verifying within the transaction device an authorization to use the embedded content; and
c. utilizing the embedded content in response to the authorization.

15. The method according to claim 14 further comprising encrypting the embedded content upon receiving the embedded content within the transaction device.

16. The method according to claim 14 wherein utilizing the embedded content further comprising decrypting the embedded content.

17. The method according to claim 14 further comprising encrypting the embedded content in response to not verifying the authorization.

18. The method according to claim 14 further comprising transmitting a payment from the transaction device to a vendor based on the embedded content.

19. The method according to claim 14 further comprising securely transmitting a payment from the transaction device to a vendor based on the embedded content through a transaction privacy clearing house.

20. The method according to claim 14 further comprising transmitting the embedded content from the transaction device to a remote device.

21. The method according to claim 20 further comprising:
a. locally verifying a permission to use the embedded content within the remote device; and
b. utilizing the embedded content in response to the permission.

22. The method according to claim 14 further comprising authenticating usage of the transaction device via a pin code.

23. The method according to claim 14 further comprising authenticating usage of the transaction device via a biometric parameter.

24. The method according to claim 23 wherein the biometric parameter is a fingerprint.

25. The method according to claim 23 wherein the biometric parameter is an iris scan.

26. The method according to claim 14 further comprising automatically calculating individual payments to multiple vendors based on the embedded content.

27. The method according to claim 14 further comprising providing the authorization in response to a local verification of sufficient funds within the transaction device.

28. The method according to claim 14 further comprising providing the authorization in response to a confirmed payment by the transaction device.

29. A method comprising:
a. receiving embedded content within a transaction device;
b. requesting a payment prior to using the embedded content on the transaction device;
c. providing the payment from the transaction device in response to requesting the payment; and
d. utilizing the embedded content through the transaction device in response to providing the payment.

30. The method according to claim 29 further comprising encrypting the embedded content upon receiving the embedded content within the transaction device.

31. The method according to claim 29 wherein utilizing the embedded content further comprising decrypting the embedded content.

32. The method according to claim 29 further comprising encrypting the embedded content prior to the step of providing the payment.

33. The method according to claim 29 wherein providing the payment from the transaction device to a vendor is based on the embedded content.

34. The method according to claim 29 wherein providing the payment from the transaction device to a vendor is based on the embedded content and is routed through a transaction privacy clearing house.

35. The method according to claim 29 further comprising transmitting the embedded content from the transaction device to a remote device.

36. The method according to claim 29 further comprising authenticating usage of the transaction device via a pin code.

37. The method according to claim 29 further comprising authenticating usage of the transaction device via a biometric parameter.

38. The method according to claim 37 wherein the biometric parameter is a fingerprint.

39. The method according to claim 37 wherein the biometric parameter is an iris scan.

40. The method according to claim 29 further comprising automatically calculating individual payments to multiple vendors based on the embedded content.

41. A method comprising:
a. transmitting embedded content from a first transaction device to a second transaction device; and
b. automatically requesting a payment from the second transaction device to a source of the embedded data in response to the embedded data.

42. The method according to claim 41 further comprising transmitting the payment from the second transaction device to the source through a secure financial transaction.

43. The method according to claim 42 wherein the secure financial transaction is routed through a transaction privacy clearing house.

44. The method according to claim 41 further comprising utilizing the embedded content by the second transaction device.

45. A method comprising:
a. receiving embedded content within a transaction device;
b. receiving a payment request in response to the embedded content;
c. transmitting the payment from the transaction device to a single location;
d. receiving a first portion of the payment by a first source of the embedded content; and
e. receiving a second portion of the payment by a second source of the embedded content.

46. The method according to claim 45 wherein the single location is a transaction privacy clearing house.

47. A computer-readable medium having computer executable instructions for performing a method comprising:
a. receiving embedded content within a transaction device;
b. locally verifying within the transaction device an authorization to use the embedded content; and
c. utilizing the embedded content in response to the authorization.
